(19) United States
(12) Patent Application Publication
(10) Pub. No.: US 2025/0124399 A1
(43) Pub. Date: Apr. 17, 2025

(54) PURCHASE PLANNING SYSTEM AND METHOD

(71) Applicant: Reuven NANIKASHVILI, Ashdod (IL)

(72) Inventor: Reuven NANIKASHVILI, Ashdod (IL)

(21) Appl. No.: 18/682,141

(22) PCT Filed: Aug. 8, 2022
(86) PCT No.: PCT/IL2022/050862

§ 371 Date: Feb. 8, 2024

(30) Foreign Application Priority Data
Aug. 9, 2021 (IL) 285478

(51) Int. Cl. G06Q 10/0836; G06Q 30/0601

(52) U.S. Cl. CPC G06Q 10/0836; G06Q 30/0635

(57) ABSTRACT

A purchase planning system comprises one or more computerized devices, each of said computerized devices having a processor on which is running a corresponding client application; and an application server for hosting each of said one or more client applications, wherein said application server is configured to communicate with at least one additional servers, each of said additional servers being associated with a different pickup center, wherein each of said one or more client applications is configured to receive a purchase request of a product of interest from a corresponding user and calculate an estimated time to purchase (ETP) in order to obtain the product following the time when the purchase request was received, in less than a maximal time specified, in advance, by said user, wherein the calculation of the ETP considers at least the user location and the destination being the location of an available product, wherein each of said client application displays a list of pickup centers that meet said maximal time, according to the ETP calculation.

### FIELD OF THE INVENTION

The present invention relates to the field of recommendation systems. More particularly, the invention relates to a purchase planning system and method for establishing preferable purchase related considerations.

### BACKGROUND OF THE INVENTION

The majority of modern commerce is based on electronic commerce (e-commerce). Many purchases are made online, with many online stores offering similar or even identical products. Some retail stores, often called brick and mortar businesses, additionally maintain a presence online by linking physical and online offerings, such as offering either personal pickup services or shipping the purchased product to a specified location.

The main difference between various online stores relates to several parameters of importance to potential customers who are interested in making a best purchase with respect to personal needs and preferences, including availability of the product, its price, discounts offered to credit card or loyalty card holders, shipping time of the product, and arrival time to a physical store.

As a result of the large number of possibilities available to someone wishing to purchase a product or a service online, optimizing and personalizing the purchasing process is prolonged and very time consuming to potential customers, taking many hours and even many days and often without satisfactory results. Moreover, potential customers also have the burden of having to consider the relatively large number of messages including emails that are received every day on their computerized devices, such as a mobile phone, personal computer, laptop computer and smart TV, and that each promotes a different discount. Most people cannot remember the content of all the messages while planning a purchase that should take into account one or more discounts to which he is entitled.

No algorithm or other technological tools are known to be able to properly filter out unwanted possibilities when a potential customer is searching for a product or a service online. For example, if the client would like to purchase the product within 24 hours, all stores offering products that the delivery time is more than 24 hours, even at lower prices, are not relevant for this client.

The prolonged purchasing process is additionally bothersome since most potential customers have limited time, usually no more than a few hours, to make a purchase, and this limited time generally does not suffice to achieve satisfactory results.

The prolonged time needed to suitably optimize a purchase stems from the large number of enterprises that aggressively compete for e-commerce business. There is consequently a large variance from one store to another in terms of parameters such as availability of the product, its price, sales, discounts offered to credit card or loyalty card holders, discounts offered to a potential customer via various digital networks, delivery or shipping time of the product, and arrival time to a physical store, for the same product.

Even if the potential customer has sufficient time to adequately weigh the various possibilities provided by each store, the potential customer is incapable of making an optimal purchasing decision since he is unaware of some of the following considerations or parameters that can influence the potential customer's decision: (a) short-term shipping time of the product, since he is unaware of the current traffic congestion on the roads, whether the store is currently open or closed, and the availability of the product at the store that was contacted, (b) profitability of making a personal pickup when taking into account transportation costs back and forth as opposed to costs of a delivery service, (c) discounts or sale offered to credit card or loyalty card holders, and (d) any other discount to which he is entitled from a digital network platform and/or a digital advertising system or application.

Regarding the decision of making a personal pickup or ordering a delivery service, the potential customer is unable to weigh in real-time which decision is more profitable, particularly since he will not make an optimization investigation that will include the cost of his lost time, or the cost of the trip that involves comparing the transportation cost using a personal car to existing modes of public transportation, such as bus, train, and taxi, or alternative means of transportation, such as bicycle and electric scooter. Also, the potential customer generally does not take into account ancillary costs associated with driving such as parking costs and the cost of his lost time when comparing the costs of a delivery service.

The potential customer does not know which of the credit cards or loyalty cards that he holds is preferable to be used at the time of the purchase in order to optimize the transaction. The potential customer is also unaware of whether he can obtain the same product in approximately the same time or approximately at the same time if purchased from another store.

It is an object of the present invention to provide a purchase planning system and method for purchasing a product online that facilitate optimizing the purchase process at the customer level and according to predefined preferences.

It is an additional object of the present invention to provide a purchase planning system that is configured to filter out unwanted possibilities when a potential customer is searching for a product online and to thereby significantly reduce the time needed to make a purchase relative to prior art practice.

Other objects and advantages of the invention will become apparent as the description proceeds.

### SUMMARY OF THE INVENTION

A purchase planning system comprises one or more computerized devices, each of said computerized devices having a processor on which is running a corresponding client application; and an application server for hosting each of said one or more client applications, wherein said application server is configured to communicate with at least one additional servers, each of said additional servers being associated with a different pickup center, wherein each of said one or more client applications is configured to receive a purchase request of a product of interest from a corresponding user and calculate an estimated time to purchase (ETP) in order to obtain the product following the time when the purchase request was received, in less than a maximal time specified, in advance, by said user, wherein the calculation of the ETP considers at least the user location and the destination being the location of an available product, wherein each of said client application displays a list of pickup centers that meet said maximal time, according to the ETP calculation.

The system configured to calculate the ETP (estimated time to Purchase) based on the many parameters such as: ETP (Time duration that client requires to get the product), current location of the client, target price of the product, data related to the intended means of transportation in order to collect the product from the shop, type of delivery service (such as: self-pick-up, delivery by pick-up center, delivery by third party—delivery service company), availability of the product (in stock, will be available in X hours, days), N—number of ETP (the number of weighted best options to display), maximum ETP (time to purchase), maximum time that client can wait for the product, user's personal data, types of client's member cards and credit cards, etc.

As referred to herein, a “pickup center” means not only a retail store whereat a customer personally visits in order to obtain guidance in the decision making process of whether to purchase the product of interest and ultimately to purchase the product of interest, but also a warehouse for storing goods including the product of interest which may have been purchased by means of an online store.

As referred to herein, an “estimated time to purchase” includes both pick-up time of a user relative to a selected pickup center, usually based on a selected mode of transportation, and delivery time of the product of interest from the selected pickup center to a user location, usually by means of a delivery service.

In one aspect, each of said client applications is additionally configured to query each of the at least one additional pickup center servers as to an availability of the product of interest; output a list of each pickup center at which the product of interest is available on an electronic document; and acquire current location data of a given one of the one or more computerized devices and of each of the pickup centers at which the product of interest is available.

In one aspect, the application is configured to calculate the ETP from a current location of the given computerized device to the location of each pickup center at which the product of interest is available.

In one aspect, the application is additionally configured to calculate the ETP with respect to intended transportation means of the corresponding user.

In one aspect, the application is configured to receive data related to the intended transportation means and to the user-specified time together with the purchase request.

In one aspect, the application is additionally configured to rank the list of each pickup center on the electronic document according to the ETP, wherein said list can be updated within the user-specified time.

In one aspect, the application is additionally configured to navigate the user to a selected one of the listed pickup centers and to suggest type of transportation or/and type of delivery service (such as: self-pick-up, delivery by pickup center, delivery by third party—delivery service company) to achieve a customer-required estimated time to purchase (ETP).

In one aspect, the application is configured to calculate the ETP of the product of interest from each pickup center at which the product of interest is available to a user-specified location.

In one aspect, the computerized device also has a memory on which are stored instructions, and wherein the application interfaces with a multi-modal search engine also running on the processor of the computerized device, such that when the instructions are executed, said search engine is commanded to search the plurality of pickup center servers, and to retrieve therefrom purchase related data associated with the product of interest, and that the application ranks search results on the electronic document by weighting said purchase related data including ETP data.

In one aspect, the purchase related data associated with the product of interest includes at least one mode, wherein the purchase related data of the at least one mode may comprise: data related to a degree of reduced cost that is being offered for the product of interest or data related to a shortened time to obtain the product of interest, such that the product of interest is able to be obtained by the user within the user-specified ETP, or the purchase related data is availability data, associated with a corresponding pickup center.

In one aspect, the computerized device additionally has a machine learning module for processing the retrieved at least one mode of purchase related data. The machine learning module may be configured to filter the retrieved purchase related data with a user-specific purchase profile.

A computer implemented method for planning to purchase a product using a client application operating over an online network and running on a processor of a computerized device comprises the steps of selecting a product of interest to a user; and calculating a purchase-related estimated time to purchase (ETP), for each of at least one pickup center at which the product of interest is available, following the time when a purchase request that included said step of selecting a product of interest was entered to the application, wherein the ETP is less than a user-specified time.

In one aspect, the method further comprises the steps of querying each of at least one server associated with a corresponding pickup center as to an availability of the product of interest; and acquiring current location data of the computerized device and of each of the pickup centers at which the product of interest is available.

In one aspect, the method further comprises the step of making a purchase of the product of interest with a selected one of the pickup centers while interacting with the application and considering the product availability.

In one aspect, the application interfaces with a multi-modal search engine and said search engine searches the at least one server, and retrieves therefrom, at least one mode purchase related data associated with the product of interest, whereby the application ranks search results by weighting said at least one mode purchase related data.

In one aspect, the retrieved modes of purchase related data are processed by a machine learning module.

In one aspect, the machine learning module filters the retrieved modes of purchase related data with a user-specific purchase profile.

### BRIEF DESCRIPTION OF THE DRAWINGS

In the drawings:

FIG. 1 is a schematic illustration of an embodiment of a purchase planning system;

FIG. 2 is an embodiment of a method for optimizing the purchase of a product;

FIG. 3 is another embodiment of a method for optimizing the purchase of a product;

FIG. 4 is a method for generated user profiles;

FIG. 5 is a method for conducting a basic search; and

FIG. 6 is a method for conducting an advanced search.

### DETAILED DESCRIPTION OF THE INVENTION

The purchase planning system facilitates optimizing the purchase of a product or a service, usually made online and generally in real-time, according to the needs and parameters predefined by the potential customer, generally including the availability of the product, its price, distance from a destination location, delivery costs, delivery time, pickup time when travelling by a selected type of public transportation, payment type, benefits offered to loyalty card or coupon holders, and discounts offered by various advertising web sites.

A dedicated application is used as a tool that assists the potential customer in making a purchasing decision and potential shop's owner to make the optimized pricing for his products. The application is based on a machine learning module, and is adapted to find an optimal purchase for the potential customer within a customer-specified estimated time to purchase (ETP) that takes into account the potential customer's personal needs and preferences as well as the constraints of personal pickup as opposed to delivery of the product directly to the customer.

With use of the dedicated application and the entire purchase planning system, the potential customer is provided with a sufficiently large amount of decision making capabilities to purchase a product or service at an optimal cost and to obtain the product or service within an optimal time. A search conducted with the dedicated application is quick, and the results are transferred to the potential customer in real-time by the press of a button.

The machine learning modules of the system learn characteristics of the potential customer while collecting purchase related information in accordance with customer-specified definitions and taking into account previous purchases made by the same potential customer. These learned characteristics help formulate an accepted deviation from the customer-specified ETP and also promote finding an optimal purchase for the potential customer.

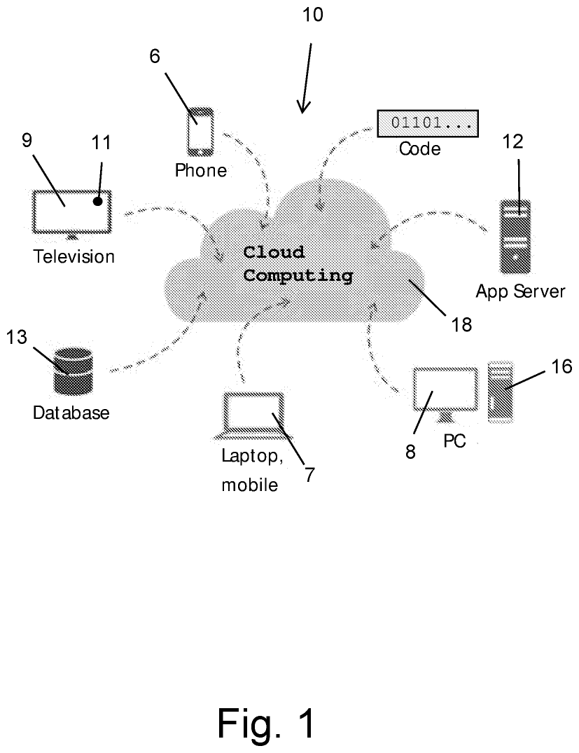

FIG. 1 schematically illustrates the architecture of purchase planning system 10 according to one embodiment.

System 10 comprises one or more computerized devices, for example mobile phone 6 such as a smartphone or a tablet, laptop computer 7, wired personal computer 8, and smart TV 9, on the processor of each of which is running the dedicated application 11. The dedicated application 11, which is configured to be compatible with many different types of operating systems such as iOS, Android, Linux, macOS and Windows, can be downloaded from application server 12, or alternatively from the App Store of iOS or Android and then installed on the computerized device. The machine learning modules used for updating the dedicated application, and the files associated with the modules, are stored on database 13.

Purchase planning system 10 is operable in conjunction with a plurality of distributed servers 16, each of which constituting a source of purchase related data. Each of servers 16 may be associated with a different enterprise providing a product or a service, to collect enterprise-specific data. Some of the enterprise-specific data is private and is not publicly accessible, while other enterprise-specific data is available to be downloaded and provides information regarding a specific aspect of purchasing a product or a service, which is hereinafter referred to as a “mode”. A mode may be for example a cost of the product or service, and/o the availability of the product, and/or time to obtain the searched/required product.

One novel aspect of the purchase planning system is the ability to synthesize the different modes and to thereby assist in finding an optimal purchase for the potential customer. A multi-modal search engine is employed to achieve this goal, and is configured to receive a purchase request of a product of interest from a corresponding user and to retrieve from first and second servers at least one mode of purchase related data associated with the product of interest. For example, the search engine retrieves from the first and second servers one or more mode of purchase related data, respectively, associated with the product of interest.

A cloud service 18, generally deployed as cloud computing, enables each of the distributed computerized devices 6-9 to be in data communication with both application server 12 and database 13. Enterprises relying on cloud computing are advantageously able to minimize or altogether eliminate up-front IT infrastructure costs while being able to easily allocate resources to users.

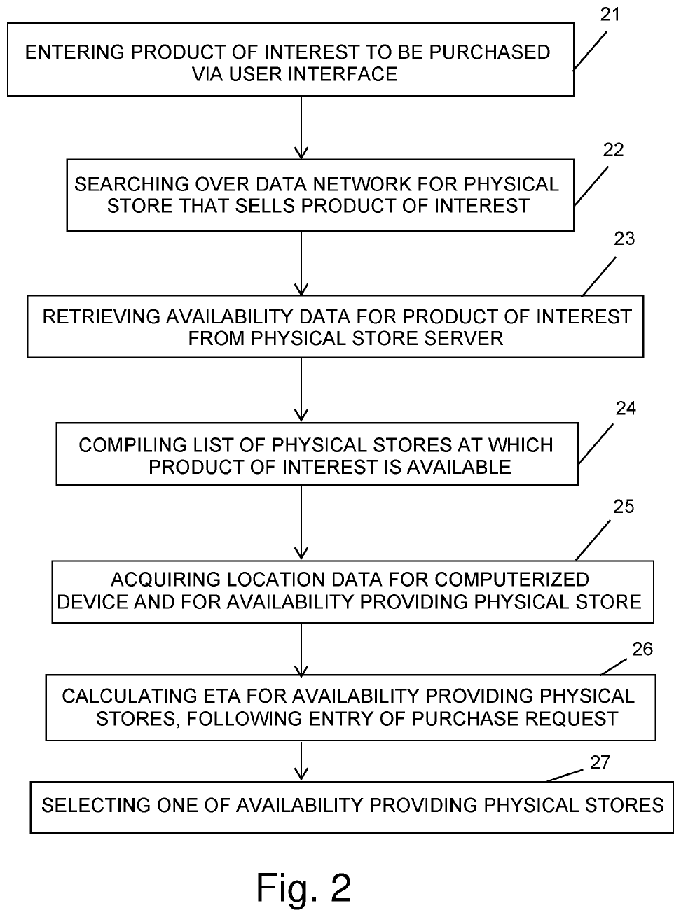

In a first embodiment illustrated in FIG. 2, the purchase of a product is optimized by considering its availability at a pickup center. Many times a user is in urgent need of a specific product, such as an electronic component needed to complete a prototype prior to being presented to investors or a gift that is needed to be presented during an important meeting that will take place within a few hours; however, the user is at times dismayed after rushing to make a pickup that the specific product is out of stock.

For the benefit of on-demand users who place online orders and expect to receive the ordered product at a curbside or an in-store pickup with a minimal waiting time, such as of two minutes, a dedicated purchase-optimizing application interfacing with a search engine and operating over an online data network such as the Internet is used. The application is generally installed in the mobile device of the user for increased usability when in transit, but may also be installed on a stationary computerized device.

After the user accesses the user interface of the application and enters a desired product to be purchased together with the purchase request in step 21, the search engine searches over the data network in step 22 for enterprises that have a pickup center that sells the desired product. The application is configured with a code that links the website of the pickup center selling the desired product to an inventory management system of the pickup center, and then in step 23 queries the server associated with the corresponding pickup center, and particularly its inventory management system, as to an availability of the product of interest, whereupon availability data is retrieved therefrom. Alternatively, the application server retrieves availability data of the product of interest from a database connected with the pickup center server or with the inventory management system.

A list is compiled in step 24 of each pickup center at which the product of interest is available, and may be displayed on a webpage, or any other electronic document. In step 25, the application acquires current location data of the user's mobile device by means of a navigation system such as GPS, and also location data of each listed pickup center at which the product of interest is available. Based on the location data, the application is accordingly able to calculate the purchase-related estimated time to purchase (ETP) in step 26 for each of the pickup centers at which the product of interest is available, following the time when the purchase request was entered to the application in step 21. To minimize computer resources, the ETP data is preferably calculated only for those pickup centers for which the ETP is less than a user-specified time.

Thus, after one of the pickup centers is selected in step 27, the user is able to obtain the product of interest at an expected time while being assured that the product of interest is in stock.

As previously explained, the “estimated time to purchase” is defined as a calculated time not only from a current location of the computerized device to the location of the selected pickup center at which the product of interest is available for pickup, for example with respect to the intended transportation means of the user, but also from the selected pickup center to a user-specified location when the product of interest is being delivered thereto.

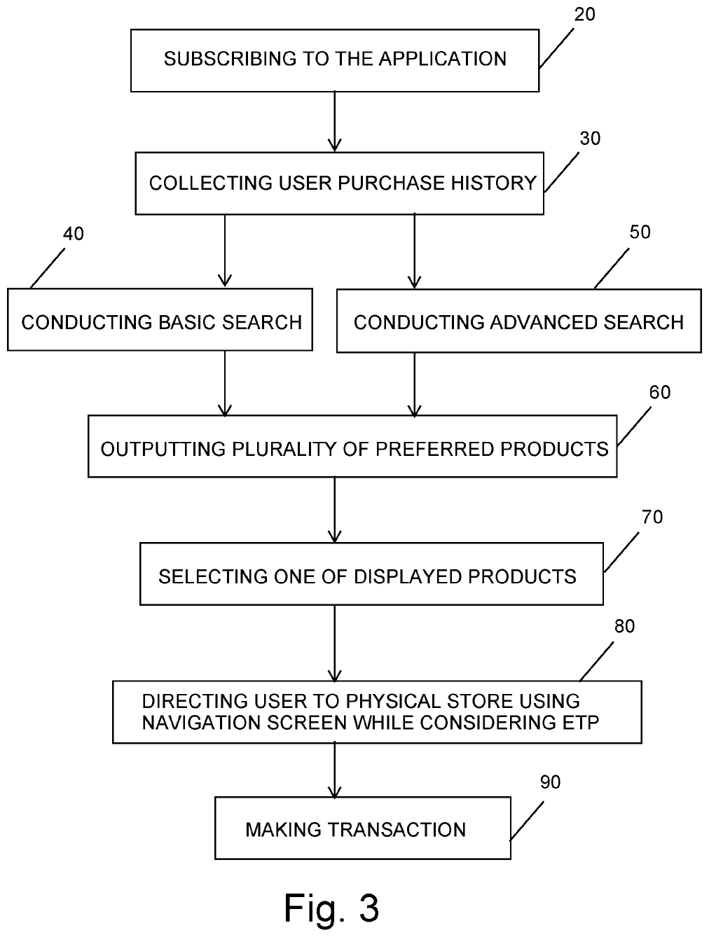

FIG. 3 illustrates a general method for optimizing the purchase of a product, according to one embodiment. A user interface provided with the dedication application which is installed on a computerized device for assisting the user in purchase optimization may be employed.

Firstly, the user subscribes to the application in step 20 with a selected username and password in order to be authorized to access the application. User purchase history is then collected in step 30, including places and ways that a purchase was made. The user purchase history helps to filter out search results that are irrelevant to the user. A product search is then conducted, whether by a basic search in step 40 or by an advanced search in step 50 after a suitable button of the user interface is selected. A plurality of preferred products, e.g., three, are then output in step 60. After the user selects one of the displayed products in step 70, a navigation screen is displayed in step 80 for the selected product that directs the user to a pickup center while taking into account the ETP. A transaction is then made in step 90.

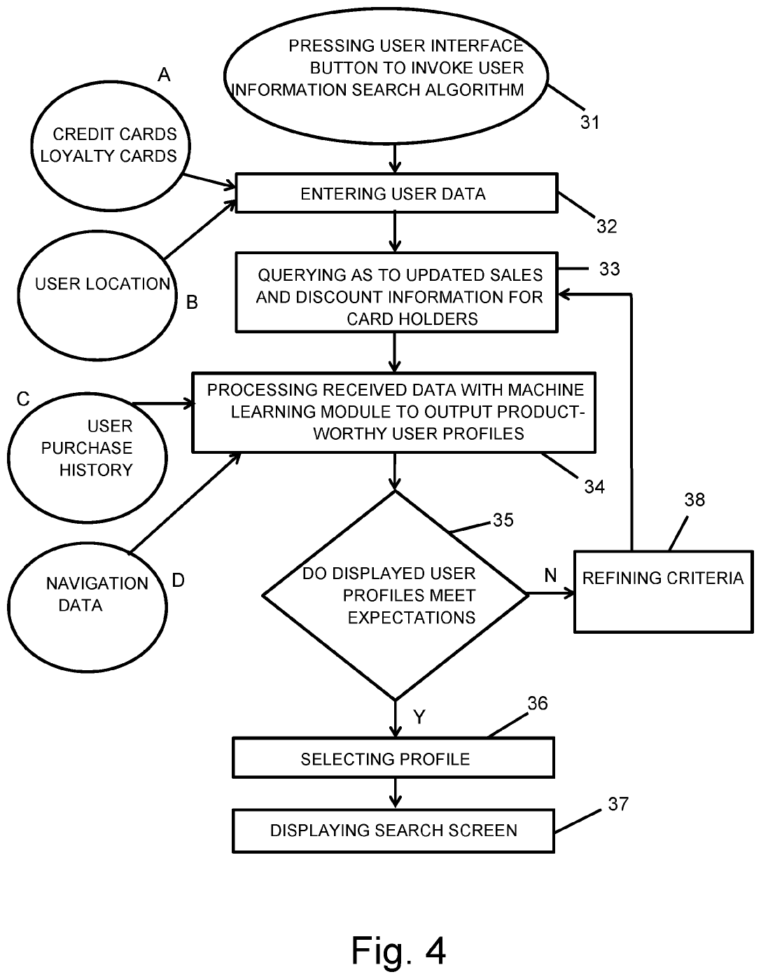

Referring now to FIG. 4, user purchase history is able to be collected once the user information search algorithm is invoked in step 31 by pressing a suitable button in the user interface. After the user information search algorithm has been invoked, the user is requested to enter in step 32 user data related to all user-held credit cards and loyalty cards A and to the current user location B, the user location B being able to be entered automatically through a location feature of a mobile phone. Queries are directed to the credit card and loyalty card companies in step 33 as to updated information relating to sales and discounts for the card holders. This information is divulged after user-sensitive information provided by the user in step 32 is transmitted.

After the application receives user purchase history C from the credit card and loyalty card companies and navigation data D from a GPS application accessed by the user during a time of a purchase, the search algorithm processes the received data A-D in step 34 by utilizing a machine learning module to output preliminary groups of user-specific purchase-worthy products. Each group reflects the manner how a purchase was made by the user within a predetermined period, e.g. six months, and is referred to herein as a “user profile”. Exemplary user profiles including a furniture-purchasing profile for purchasing furniture that is delivered from a store located within a 50-km radius from the user's home, an electronic device purchasing profile for purchasing electronic devices by personal pickup at a store located within a 30-km radius from the user's home, and a toy purchasing profile for purchasing toys with a loyalty card when a discount of 25% was offered.

A list of user profiles of user-specific purchase-worthy products is displayed in step 35. If these preliminary groups meet the user's expectations after being viewed, the user selects one of the listed profiles in step 36 as reflecting the type of purchase that the user wants to presently make, whereupon a search screen is displayed in step 37.

If the displayed profiles do not meet the user's expectations, the criteria for producing data A-D is refined in step 38 and step 33 is repeated, until the displayed profiles meet the user's expectations.

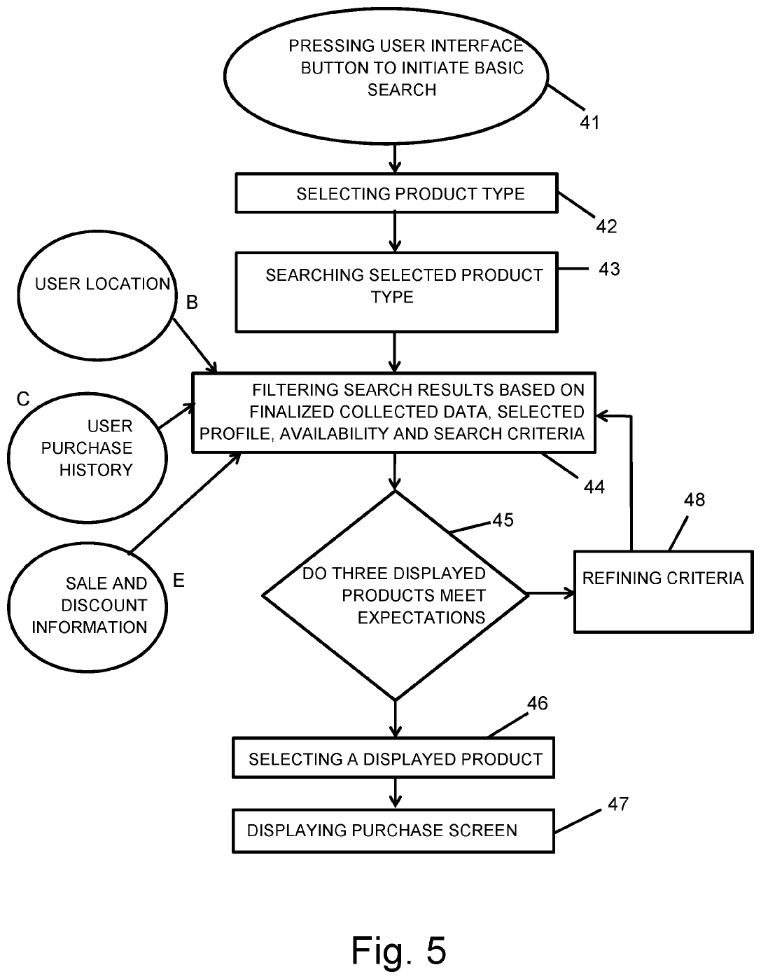

During a basic search illustrated in FIG. 5, after a suitable button in the user interface is pressed in step 41, the user selects a product type desired to be purchased in step 42. The selected product type is searched online in step 43. The search results are filtered in step 44 based on the finalized collected data B, C and E related to current user location, user purchase history, and updated sale and discount information for card holders, respectively, as well as on the user profile that was defined in the user purchase history collection stage, availability at a pickup center, and predetermined search criteria. Following filtering, three recommended specific products that are found to have the most inexpensive price and are consistent with the purchasing needs of the user and with current sales and discounts that are being offered are displayed in step 45.

If the three displayed specific products meet the user's expectations after being viewed, the user selects one of the displayed specific products in step 46 as being the personal best choice for making a purchase, whereupon a purchase screen is displayed in step 47.

If the three displayed specific products or services do not meet the user's expectations, the search criteria are refined in step 48 and step 44 is repeated, until the three displayed products meet the user's expectations.

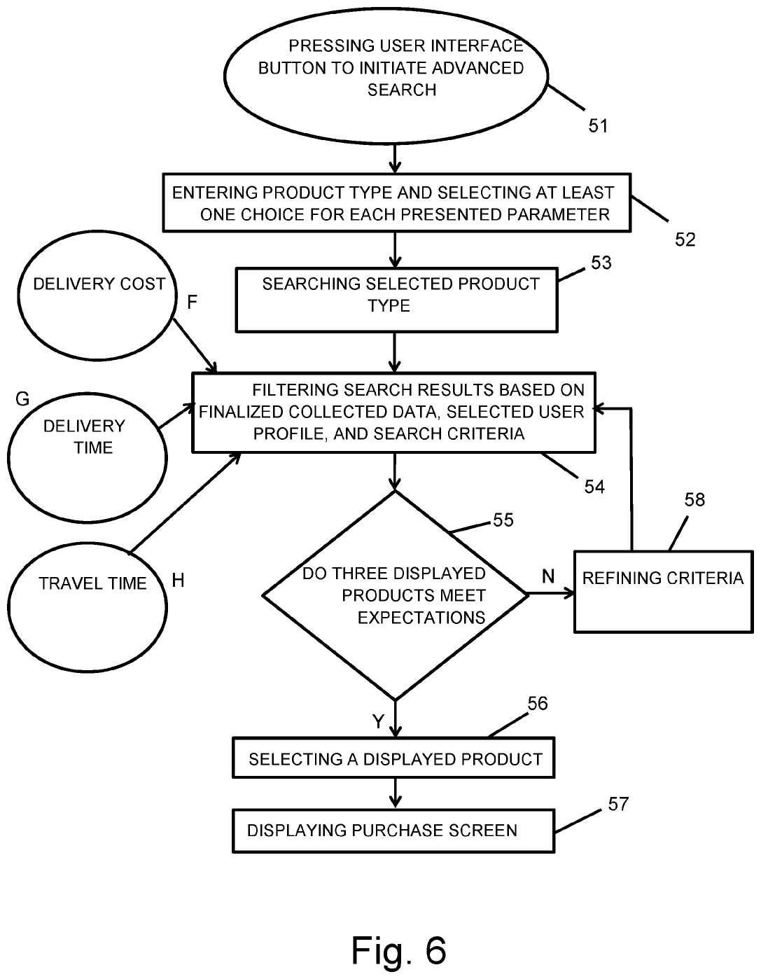

During an advanced search illustrated in FIG. 6, after a suitable button in the user interface is pressed in step 51, the advanced search screen is displayed. A purchase is able to be optimized during an advanced search by taking into account transit considerations in addition to cost considerations. The advanced search screen provides a form in which several purchase parameters are presented, and, in step 52, the user has to enter a product type and select at least one choice for each parameter that is presented in relation to the entered product type.

Exemplary parameters when the selected product type is a television include size, manufacturer, distance from home, pickup or delivery preference, maximum waiting time, and price.

The selected product is searched in step 53 by the search engine online or through a cloud service in accordance with the selected checkbox choices. This search is conducted with respect to the following information acquired for each pickup center providing the selected product: delivery cost F, delivery time G and travel time H to a pickup center for different means of transportation. The search results are filtered in step 54 based on the finalized data C and E that was collected, the user profile that was defined in the user purchase history collection stage, and predetermined search criteria used by a machine learning module. Expected purchasing patterns of the user are learned by the machine learning module by weighing various pickup possibilities such as immediate pickup, pickup within 2-3 hours, pickup within 24 hours and pickup within a week in comparison with the cost of his lost time by considering what could be accomplished instead of having to travel to the pickup center within a given time. Following filtering, three recommended products are displayed that are found to have the most inexpensive price and are consistent with the purchasing needs of the user and with current sales and discounts that are being offered.

If the three displayed products meet the user's expectations after being viewed, the user selects one of the displayed products in step 56 as being the personal best choice for making a purchase, whereupon a purchase screen is displayed in step 57.

If the three displayed products do not meet the user's expectations, the search criteria are refined in step 58 and step 54 is repeated, until the three displayed products meet the user's expectations.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A purchase planning system, comprising:
a) one or more computerized devices, each of said computerized devices having a processor on which is running a corresponding client application; and
b) an application server for hosting each of said one or more client applications, wherein said application server is configured to communicate with at least one additional servers, each of said additional servers being associated with a different pickup center, wherein each of said one or more client applications is configured to receive a purchase request of a product of interest from a corresponding user and calculate an estimated time to purchase (ETP) in order to obtain the product following the time when the purchase request was received, in less than a maximal time specified, in advance, by said user, wherein the calculation of the ETP considers at least the user location and the destination being the location of an available product, wherein each of said client application displays a list of pickup centers that meet said maximal time, according to the ETP calculation.

2. The purchase planning system according to claim 1, wherein each of said client applications is additionally configured to:
i. query each of the at least one additional pickup center servers as to an availability of the product of interest;
ii. output a list of pickup centers at which the product of interest is available on an electronic document;
iii. acquire current location data of a given one or more computerized devices and of each of the pickup centers at which the product of interest is available; and
iv. calculate the ETP from a current location of the given computerized device to the location of each pickup center at which the product of interest is available.

3. The purchase planning system according to claim 2, wherein the ETP is calculated with respect to intended and/or available transportation means of the corresponding user.

4. The purchase planning system according to claim 3, wherein the application is configured to receive data related to the intended transportation means and to the user-specified time together with the purchase request.

5. The purchase planning system according to claim 4, wherein the application is configured to calculate a short-term pick-up/shipping time of the product based on the current traffic congestion on the roads and or whether the pickup center is currently open or closed and/or the availability of the product at the pickup center that was contacted.

6. The purchase planning system according to claim 3, wherein the application is additionally configured to rank the list of each pickup center on the electronic document according to the ETP, wherein said list can be updated within the user-specified time.

7. The purchase planning system according to claim 6, wherein the ranking is based on one or more of the following parameters: target price as defined by the user, profitability of making a personal pickup when taking into account transportation costs, delivery cost, offered discounts/sales to which the user is entitled, information received from a digital network platform or/and a digital advertising system/application, or any combination thereof.

8. The purchase planning system according to claim 6, wherein the application is additionally configured to navigate the user to a selected one of the listed pickup centers, and to suggest type of transportation or/and type of delivery service (such as: self-pick-up, delivery by pickup center, delivery by third party—delivery service company) to achieve the ETP.

9. The purchase planning system according to claim 2, wherein the application is configured to calculate the estimated time to purchase (ETP) of the product of interest from each pickup center at which the product of interest is available to a user-specified location.

10. The purchase planning system according to claim 1, wherein the computerized device also has a memory on which are stored instructions, and wherein the application interfaces with a multi-modal search engine also running on the processor of the computerized device, such that when the instructions are executed, said search engine is commanded to search the plurality of pickup center servers, and to retrieve therefrom, at least one mode of purchase related data associated with the product of interest, and that the application ranks search results on the electronic document by weighting said at least one mode of purchase related data including ETP data.

11. The purchase planning system according to claim 10, wherein the at least one mode purchase related data is such as: data related to a degree of reduced cost that is being offered for the product of interest, and/or the purchase related data is data related to a shortened time to obtain the product of interest such that the product of interest is able to be obtained by the user within the user-specified ETP, and/or the purchase related data is availability data, associated with a corresponding pickup center.

12. The purchase planning system according to claim 10, wherein the computerized device additionally has a machine learning module for processing the retrieved one or more modes of purchase related data.

13. The purchase planning system according to claim 12, wherein the machine learning module is configured to filter the retrieved purchase related data with a user-specific purchase profile.

14. A computer implemented method for planning to purchase a product using a client application operating over an online network and running on a processor of a computerized device, comprising the steps of:
a) selecting a product of interest to a user; and
b) calculating an estimated time to purchase (ETP) in order to obtain the product in less than a maximal time specified, in advance, by said user, for each of at least one pickup center at which the product of interest is available, following the time when a purchase request that included said step of selecting a product of interest was entered to the application, wherein the calculation of the ETP considers at least the following: user location, the destination being the location of an available product, traffic congestion to said destination, data related to transportation to said destination, wherein each of said client application displays a list of pickup centers that meet said maximal time, according to the ETP calculation.

15. The method according to claim 14, further comprising the steps of
a) querying each of at least one server associated with a corresponding pickup center as to an availability of the product of interest; and
b) acquiring current location data of the computerized device and of each of the pickup centers at which the product of interest is available.

16. The method according to claim 14, further comprising the step of making a purchase of the product of interest with a selected one of the pickup centers while interacting with the application and considering the ETP and the product availability.

17. The method according to claim 14, wherein the application interfaces with a multi-modal search engine and said search engine searches the at least one server, and retrieves therefrom at least one mode of purchase related data associated with the product of interest, whereby the application ranks search results by weighting said at least one mode of purchase related data to achieve the customer-specified ETP.

18. The method according to claim 17, wherein the retrieved one or more modes of purchase related data are processed by a machine learning module.

19. The method according to claim 18, wherein the machine learning module filters the retrieved modes of purchase related data with a user-specific purchase profile.
